(19) United States
(12) Patent Application Publication
(10) Pub. No.: US 2020/0302344 A1
(43) Pub. Date: Sep. 24, 2020

(54) RESERVATION SYSTEM FOR FACILITATING REAL-TIME MANAGEMENT OF ROOM RESOURCES

(71) Applicant: MICROSOFT TECHNOLOGY LICENSING, LLC, Redmond, WA (US)

(72) Inventors: Stephen Aaron JUST, Bellevue, WA (US); Brian SMITH, Seattle, WA (US); William Charles THOMPSON, Duvall, WA (US); Robert Holt DEUPREE, JR., Tacoma, WA (US); Zorba John MANOLOPOULOS, Livermore, CA (US)

(73) Assignee: MICROSOFT TECHNOLOGY LICENSING, LLC, Redmond, WA (US)

(21) Appl. No.: 16/361,138

(22) Filed: Mar. 21, 2019

(51) Int. Cl. G06Q 10/02; G06F 21/34

(52) U.S. Cl. CPC G06Q 10/02; G06F 21/34

(57) ABSTRACT

A method and system for automatically joining a conference, in which a user is able to make use of a conference room or other shared resource site to be promptly auto-connected to an upcoming meeting event. The user can provide security credentials to log-into the system, and the system can access the user's calendar and automatically connect the user with their next scheduled meeting from a selected conference room or other shared resource site.

### BACKGROUND

There are a number of conferencing and room management tools presently available for facilitating the booking of conference rooms. In these cases, participants typically use a telephone, computer, or other communication device located in the conference room that is connected to a conference system or server. The meetings include an audio component and/or a visual component, such as, a shared presentation, video, whiteboard, or other multimedia, text, graphics, etc. These types of convenient conference solutions have become an indispensable form of communication for many businesses and individuals.

Typically, such conference calls involve an organizer initially scheduling a conference call and sending invitations to the desired participants. Each invited participant can be provided a subject of the conference, a call-in telephone number, a time and date for the conference call, an access code in the form of a pass code and, perhaps, a list of other participants. An invited participant is then required to call the call-in number at the particular time and date, enter a pass code and subsequently be connected to the scheduled conference call.

Conference calling enables multiple parties to conveniently meet and conduct business without the expense, both time and money, incurred by traveling to a particular location. However, while existing conference, meeting, grouping or other types of gathering systems offer many advantages, there remain significant areas for new and improved ideas for allowing users with to easily connect to their scheduled meetings as well as readily locate and use resources with which they may participate in the meeting.

### SUMMARY

A system, in accord with a first aspect of this disclosure, includes a processor and one or more computer readable medium. The computer readable medium include instructions which, when executed by the processor, cause the processor to receive, from a first user, a request for authenticating a first user identity based on a first authentication input, as well as authenticate, based on access to a user database and the first authentication input, the first user identity. The instructions also cause the processor to access a first user account associated with the first user identity and to identify a first scheduled event in which the first user account is designated as a potential attendee. The instructions further cause the processor to offer the first user, by reference to a resource management system, access to a first resource space for use during the first scheduled event, the first resource space including a first telecommunications device, and automatically establish a connection between the first telecommunications device and a system hosting the first scheduled event.

A method performed by a data processing system, in accord with a second aspect of this disclosure, includes receiving, from a first user, a request for authenticating a first user identity based on a first authentication input, as well as authenticating, based on access to a user database and the first authentication input, the first user identity. The method also includes accessing a first user account associated with the first user identity, and then identifying a first scheduled event in which the first user account is designated as a potential attendee. The method further includes offering the first user, by reference to a resource management system, access to a first resource space for use during the first scheduled event, the first resource space including a first telecommunications device, and automatically establishing a connection between the first telecommunications device and a system hosting the first scheduled event.

A computer readable medium, in accord with a third aspect of this disclosure, includes instructions stored therein which, when executed by a processor, cause the processor to perform operations that include receiving, from a first user, a request for authenticating a first user identity based on a first authentication input, as well as authenticating, based on access to a user database and the first authentication input, the first user identity. In addition, the instructions cause the processor to access a first user account associated with the first user identity, and identify first scheduled event in which the first user account is designated as a potential attendee. Furthermore, the instructions cause the processor to offer the first user, by reference to a resource management system, access to a first resource space for use during the first scheduled event, the first resource space including a first telecommunications device, and automatically establish a connection between the first telecommunications device and a system hosting the first scheduled event.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIGS. 1A and 1B illustrate an implementation of a user accessing a conference room for auto-connection to an upcoming scheduled meeting;

FIG. 2 is a diagram illustrating an implementation of a system configured to reserve a meeting room and automatically connect a user to a meeting;

FIGS. 3A and 3B depict an implementation of a user having a meal and quickly transitioning to arranging a room reservation for an upcoming meeting;

FIG. 4 is an example of a meeting room including a reservation and auto-connect system for joining a conference;

FIG. 5 is a display diagram illustrating an implementation of a user interface for an application configured to provide options for joining a conference call;

FIGS. 6 and 7 are an example of a user selecting a meeting and being automatically connected to the conference;

FIGS. 8A and 8B illustrate an example of a user selecting a meeting and being automatically connected to the conference while still outside of the meeting room;

FIGS. 9A, 9B, and 9C illustrate an example of a user selecting a meeting room and overriding the previous reservation;

FIG. 10 illustrates some examples of two factor authentication;

FIGS. 11A and 11B illustrate an example of a user selecting a room for an upcoming conference call;

FIG. 12 is a flow diagram illustrating an implementation of a process of accessing a user's calendar and facilitating a room booking for use by that user during an upcoming meeting;

FIG. 13 is a block diagram of an example computing device, which may be used to provide implementations of the mechanisms described herein; and

FIG. 14 is a block diagram illustrating components of an example machine configured to read instructions from a machine-readable medium.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

The following implementations introduce a method and system for automatically joining a scheduled conference event, where a user may be offered options for booking a room or space from which to participate in the meeting. Traditionally, connecting to scheduled meetings has included a series of steps where users can: (1) locate a resource space for conducting the meeting; (2) determine whether the space is available for their use for the duration of the meeting; (3) request use of the room; (4) proceed to log-in to a device in that space; (5) log-in to and access a personal calendar and/or meeting invite; (6) review the conference log-in instructions; (7) follow the instructions and/or enter the phone number and passcode designated for the meeting; (8) connect to the meeting; and (9) communicate with fellow participants and/or present audio or video in real-time, during the conference.

However, there are many technical problems associated with this process. For example, participants can fail to recall they have an upcoming meeting, or they may be away from a device that would facilitate their access to the meeting. In some other cases, a user may set an alarm on a personal device to remind them of the conference, but at the time of the alarm they may be away from the meeting resources (e.g., physical space, computing devices, presentation and recording equipment, viewing displays, etc.) that are needed to enable participation. This may occur even in cases where the user remembers the scheduled meeting in a timely manner, but finds they are away from the office or from the device that would facilitate their access to any conference login information, thereby significantly delaying their attempts to join the call. Users can be frustrated by the need to plan ahead for such meetings and/or the inability to join a meeting in a more fluid or impromptu manner when their schedule ‘opens up’ and they find themselves able to attend a meeting that had previously conflicted with other items on their calendar. In some other cases, a user can forget they have an upcoming meeting in which a room has not been booked. Even in cases where the user has booked a room, they may encounter situations where the room is under maintenance or otherwise undergoes changes that make the room no longer suitable for their needs, or where the resources needed for the meeting have changed.

As will be discussed below, the disclosed implementations offer a powerful set of technical solutions by which a user can easily access a space from which the necessary meeting resources are available and facilitate a timely and ready automatic connection to their meetings. The option will be provided to the user in a manner that maximizes convenience and efficiency. For example, the option to reserve a room or space and be automatically connected to a meeting can be presented to a user as he or she accesses the meeting room information terminal, the meeting room device(s), as well as via a more generalized room scheduling system and network that can identify available rooms across the organization or site.

These solutions provide a wide array of advantageous technical effects. By enabling access to a meeting room in a more ad hoc manner, as well providing a quick connection to an upcoming (or in progress) conference via the room's computing resources, users are more likely to manage their schedule in a way that increases efficiency, as well as enhances their comfort and confidence. Furthermore, this system can remove the inconvenience of having to search for available rooms with the desired facilities or remembering to return to the meeting listing to recall the meeting details, which in turn allows a user to make better use of their time and optimize the management of resources in their organization. In addition, a user can make better decisions for their day-to-day schedule and permits them greater flexibility in their usage of time and ability to travel. For example, rather than requiring users to confirm their participation in a meeting and reserve a room days or weeks in advance, users can approach their schedules in a more fluid manner, find a space to connect to a meeting for immediate use, and—without being prompted to enter access codes, pin numbers, website passwords, or other such login credentials—participate in a conference event with little effort, stress, or frustration. In some cases, the auto-connect settings or configuration may be adjusted for each conference event that occurs via reference to a user's previous connection settings and/or express preferences. As will be discussed below, users can also easily view a listing of their upcoming (or in progress) meetings at shared resource devices. In cases where multiple meetings are identified on a user's calendar, a user may also be able to view and select the meeting for which a room and quick-connection are now desired.

In general, a conference or meeting event (“meeting”) refers to a real time, or near-real time, in-person use of a physical space. In one example, this can involve an in-person communication session between two or more participants. However, in some implementations, only one person may be present in a room and connect to another participant via a telecommunications device, or a single person may wish to make use of a room at a specific time and day for their own purposes, or for passive listening of a remote meeting. Thus, the term meeting can encompass any event, activity, gathering, assembly, class, conference, convention, summit, session, get-together, congregation, reunion, or the like that may be prescheduled and includes the use of a particular resource. Some other examples can include a conference call, a World Wide Web (Web) based conference, a videoconference, a communications device usage, and/or a multi-party instant messaging (IM) or chat session. It should further be understood that references to the term “room” encompasses not only enclosed or specifically designated spaces in physical structures or buildings, but any physical space that can be the site of a meeting, and so can be enclosed or open, indoors or outdoors. The room can also include a sub-structure or component(s) within a room, such as a cubicle, computer terminal, kiosk, telephone, wall device, sub-space, conferencing audio-visual system, conference table, or other designated spaces or resources.

In addition, the term scheduled meeting or scheduled conference generally refers to a communication session that has been scheduled for a particular date/time. It should be understood that the disclosed implementations may also be applicable to meetings that have not yet been accepted (i.e., the user has not confirmed their intention to attend) or even meetings to which the user has indicated that he or she is not planning to attend.

Furthermore, while the terms “call” or “calls” will be used in the description, the described systems and methods are also applicable to session-based telecommunications in general and are not limited to voice calls. It will also be appreciated that the systems and methods are not limited to sessions and are applicable to messaging-based or packet-based communications. Thus, conference calls can include exchange of as any combination of voice data, video data, text data, image data (e.g., presentation data), file data, or any other types of data.

As a general matter, usage of the terms “automatically connect”, “automatically join”, “auto-connect”, or “auto-join” refer to the capability of a system to automatically initiate and establish a connection between a system hosting the conference event and one or more devices associated with the attendee (or the space which he or she is using) when a predetermined date and time occurs and/or specified conditions are met. For example, if an auto-connect feature is initiated, the room device or system can be configured to connect with a conferencing application and/or may begin placing outgoing telephone calls via a telephony system to the system hosting the event.

Furthermore, references to a communication application, a scheduling application, an organizer application, or simply “application” generally refer to any software applications configured to provide a means of scheduling, viewing, modifying, joining a meeting, and/or communicating or transmitting or receiving data associated with the meeting. This can include any type of electronic calendar or electronic scheduling system that is capable of tracking a user's meetings or appointments. Some such programs can include Skype®, Microsoft Teams®, Microsoft Outlook®, GoToMeeting®, WebEx®, Zoom®, Join.Me®, GoogleHangouts®, AnyMeeting® and other applications that can provide conferencing tools and/or facilitate communication or collaboration online. These are non-limiting examples, and any other communication-related application may benefit from the disclosed implementations. Specific references to a software application by name throughout this description should not therefore be understood to limit the use of the proposed systems and methods. It should further be understood that in some implementations, the application used to enable an auto-connection function or facilitate an impromptu room booking may differ from the application used to schedule the meeting, while in other implementations, they may be the same.

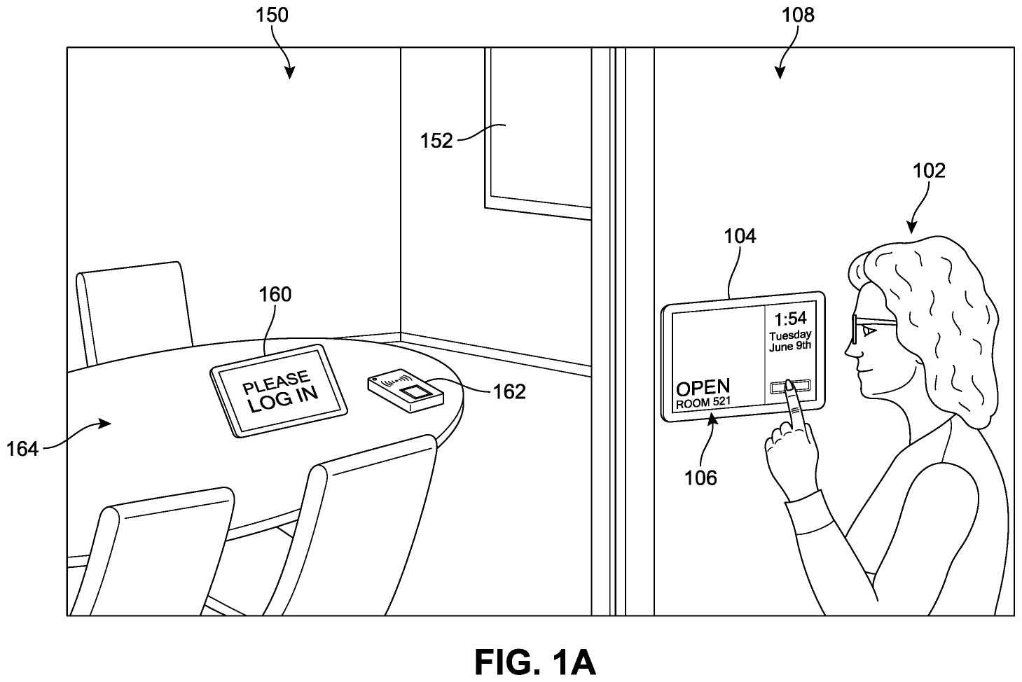

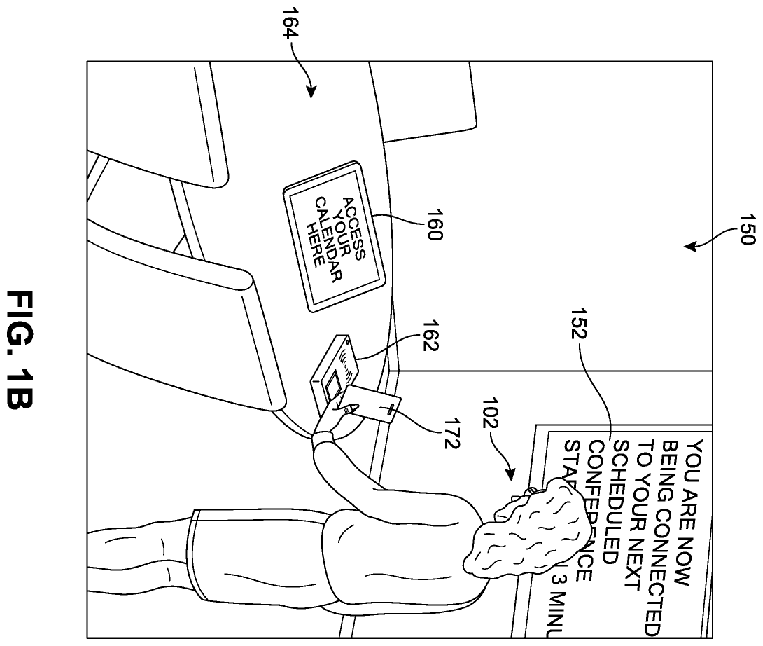

In order to better introduce the technical solutions offered by the disclosed systems and methods, FIGS. 1A and 1B present a high-level example of a representative conference environment (“environment”) for implementing a first conference room management system (“first system”) 164. In different implementations, the environment can include one or more computing devices and end-users, or simply “users”. As an example, a first user 102 is shown in FIG. 1A approaching a first conference room (“first room”) 150. In this case, the first user 102 is accessing a native control in the form of a first meeting room user interface (“first interface”) 106 on a display of a first device 104 installed on an external wall 108 of the first room 150. For purposes of illustration, the first room 150 is shown to include a second computing device (“second device”) 160 and a radio frequency identification (RFID) reader 162 that are both disposed on a conference table, as well as a larger display screen 152 mounted on a wall. It can be understood that the first device 112 and second device 160 are configured for connection to a network. In one implementation, as first user 110 initially views the first interface 106, information regarding the availability of the first room 150 may be presented on the display of the first device 104. For example, in this case, the first interface 106 indicates that the first room 150 is available or open (i.e., has not been reserved for use at this time), as well as shows the user the current time (1:54 on Tuesday June 9th). In some implementations, as shown here, the first user 102 can interact with the first interface 106 via one or more selectable options or buttons to move through or view additional information for the first room 150.

In the next scene, presented with reference to FIG. 1B, the first user 102 has chosen to enter the first room 150 and is shown approaching the conference table. As will be discussed in further detail below, a user may be provided with a means of quickly accessing their own individual or personal meeting calendar and/or information about their schedule. For example, once the first user 102 registers with the first system 164, for example by presentation of her identification badge or other type of security token (referred to herein as a token 172), and the RFID reader 162 obtains a reading of the token 172, the first system 164 can be configured to automatically access the first user' calendar, determine which meeting event is scheduled to occur soonest or nearest to the present time, and initiate a connection to that meeting. Thus, in this example, the user's security token can include a device or component that is configured for scanning or being ‘read’ by the RFID reader 162.

The resultant auto-connection, represented by a change on the display screen 152 (“You are now being connected to your next scheduled conference starting in 3 minutes”), can occur without any further input or direction by the first user 102 beyond their initial system registration, where the system registration occurred as a result of verification of the user by the system following a reading of the security token. In some implementations, the first system 164 can also offer the user further options for selecting a meeting event or other meeting settings, as represented by the display of second device 160, which informs the first user 102 that she may access her calendar here.

It may be appreciated that the benefits offered by this type of technical solution, whereby one is allowed to enjoy the resources of a meeting room as well as promptly auto-join a conference, can significantly simplify the conferencing experience process for attendees. The user is no longer required to expend time or attention in following additional steps to be connected to the call, nor are they required to designate a meeting room far in advance of a meeting time. Various mechanisms by which the option to make an impromptu room booking as well as initiate the auto-join to a scheduled meeting will be described in greater detail below.

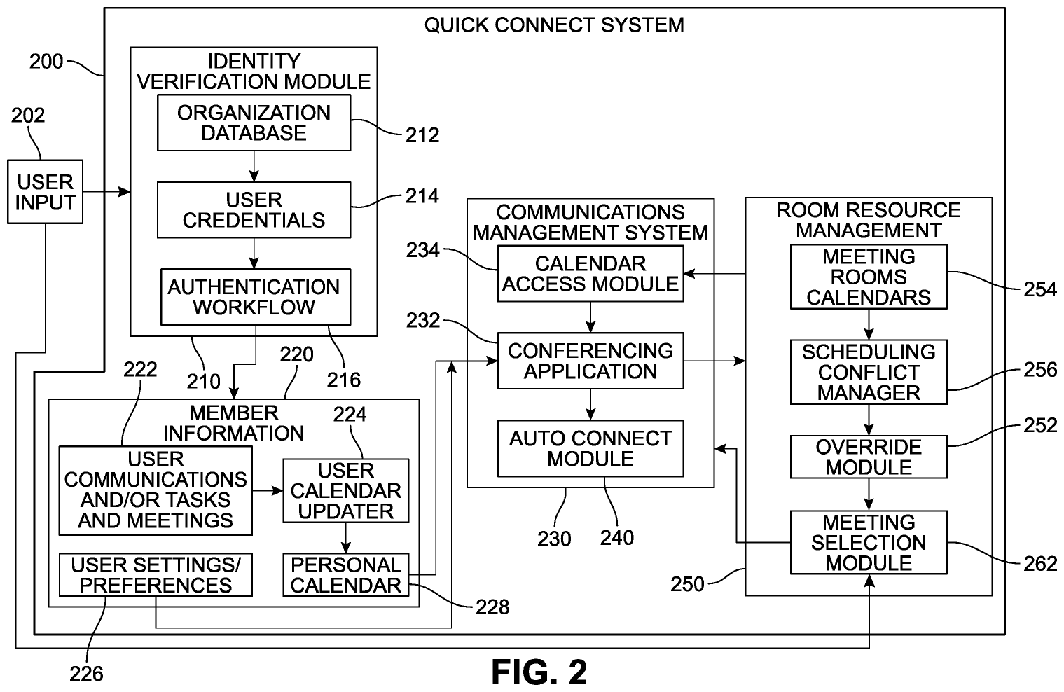

Referring now to FIG. 2, an example of a representative architecture of a room reservation and expedited connection system (“system”) 200 is depicted. In different implementations, the system 200 can be configured to transmit and receive information to/from various computing devices. Some computing devices can present user interfaces for display of room information and/or user calendars. It is to be understood that the system 200 presented here is merely an example implementation, only some aspects are presented for purposes of clarity, and that a wide variety of other implementations are possible.

As noted earlier, in order to enable access to a user's personal calendar or scheduled meetings, the system 200 must, as a preliminary matter, determine the identity of the user. In FIG. 2, the system 200 includes an identity verification module 210. The identity verification module 210 can be configured to receive a user input 202 that can be used to both recognize whether the user is associated with an account in the system and to authenticate the user. In other words, the user input(s) 202 can involve or encompass one or more types of authentication factors that will be used by the identity verification module 210 to verify the identity of the user, if that user is listed in an organization database 212 or other member directory associated with or linked to the system 200.

As a general matter, authentication factors can include various types of inputs, including biometrics, tokens, transactions, and out-of-band authentication factors. Tokens, which reflect the authentication process primarily illustrated in the figures, comprise physical devices, such as key fobs, badges, smart cards, wristlets, near-field communication devices, Bluetooth, radio-frequency identification technology, bar codes scanning, or other physical security tokens. However, it should be understood that any type of authentication factor may be utilized by the system 200, including but not limited to biometrics, transactions, and out-of-band factors. There are also other tokens that may exist in software as mobile or desktop applications that generate PIN codes for authentication. These authentication codes, also known as one-time passwords, are usually generated by a server and can be recognized as authentic by an authentication device or application. In different implementations, the system can include one or more types of readers, such as a near field communication reader, an RFID reader, or other readers capable of detecting or scanning various security tags. Thus, in some implementations, the identity verification module 210 can include provisions for accepting, processing, and allowing (or denying) access to users authenticating with any type of authentication factor. In one implementation, the system 200 can ascertain that the authenticated user is given access to all resources the user is approved for. Thus, one function of this process can be linking the authentication system with an organization's authentication data or user credentials 214. This link can trigger an authentication workflow 216 by which the user identity is verified and his/her account is accessed.

As one example, the system can be configured to receive a user input in the form of an identification badge and, in response to the user input, access a cloud or web service to look up the user associated with the badge value. This web service is designed to provide access to a database that maps RFID badge values to user IDs. For example, this can refer to an active directory identifying all active users or accounts in the system. In other implementations, the user ID may itself be listed or stored in the directory, such that any additional ‘lookup service’ is no longer necessary.

Once the user's identification has been determined and authenticated, the system 200 can access the identified member (user) information 220, and ‘look up’ or search through various user-specific data repositories, such as user communications and/or tasks and meetings 222 to identify any scheduled or tentative meeting events for which the current user may possibly be attending. This information can be collected or harvested from a central calendar application used by the organization, a social networking application, a conferencing application, user e-mails and messages, and/or events that the user is following or has liked or otherwise expressed an interest in, and pulled into a user calendar updater 224 which reflects the most recent or up-to-date view of the user's upcoming (or in progress) events. This information can be used to generate a personal calendar 228 for the current user that lists or otherwise identifies one or more upcoming events that the user may have an intention of participating in or may be of interest to the user. Some or all of this information can be shared with a communications management system 230, as discussed further below.

Similarly, in some implementations, the user's expressed preferences or settings for meetings and other telecommunication sessions, as well as their previous usage history of room or device resources while attending such meetings, can be accessed by the communication management system 230 to provide what is likely to represent the most optimal set-up experience during the conference. For example, the system 200 can establish a default setting whereby a user who primarily mutes their microphone will find the microphone already muted when they enter the conference room. Other settings, such as volume levels, auto-recording, video settings, conferencing interface mode, room lighting, etc., can be pre-set in response to specific usage patterns being detected in the user's previous use history, and/or as were identified more expressly and stored in the user's account. In some other implementations, the system 200 may determine that the user has special needs, and the meeting display should include closed captioning, or the room should include more specially designed furniture or other specifically tailored features to facilitate their conferencing experience.

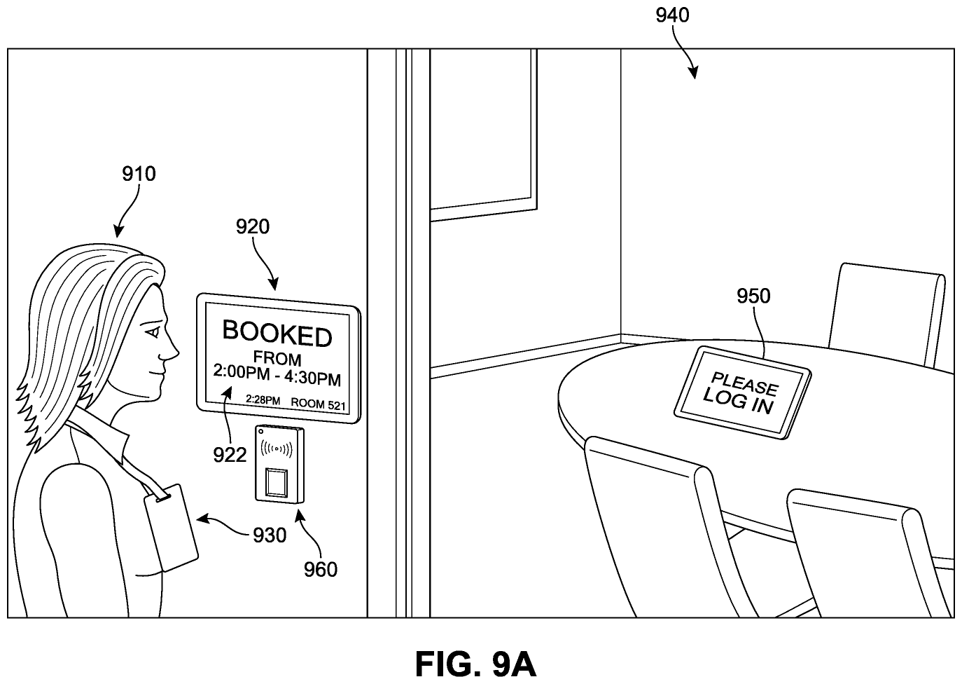

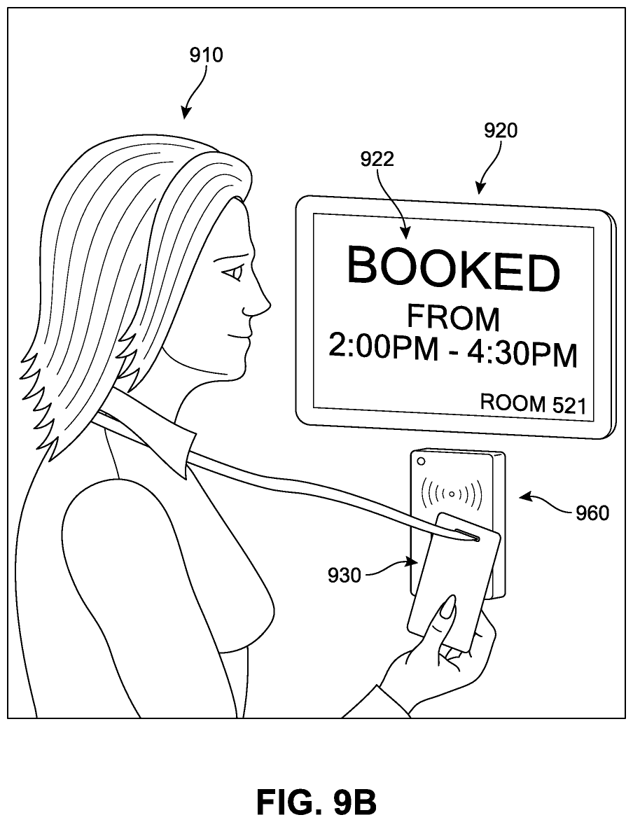

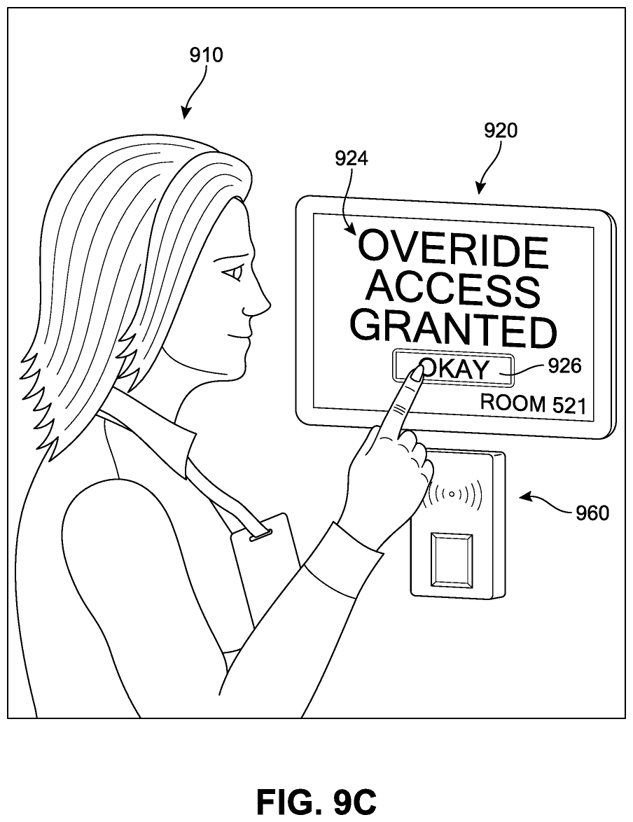

In addition, as noted earlier, the system 200 can be configured to offer or otherwise permit user access to one or more resource spaces. In some implementations, the system 200 is configured to help assign or reserve work spaces for the user via a room resource management module 250. The room resource management module 250 can access a meeting rooms calendar 254, which indicates whether a specific room is available and for what duration. This information can also be used to guide a user to a specific meeting room and/or allow the user to override previously submitted reservation(s) under certain conditions (see an override module 252). If a scheduling conflict manager 256 detects an overlap in the use of a room during the time selected by the user (i.e., a previous reservation for the room is identified), the override module 252 can in some cases be used to allow the current user to supersede and/or disregard the previous booking, as will be discussed below with reference to FIGS. 9A-9C.

Once a meeting room or other resource space has been selected by the user, the room resource management module 250 can attempt to confirm the new reservation or potential resource usage. The room resource management module 250 can query the communication management system 230 as to the expected meeting start time and duration in order to ascertain whether the desired resource is in fact available for the full duration of the event. In some implementations, for example when multiple scheduled meetings are detected, the user may be prompted to select the meeting they intend to join, which can be received by a meeting selection module 262 and submitted to the communications management system 230.

Once confirmation of the room availability is obtained and the room or space is reserved, the system 200 can initiate a process for auto-connecting the user to the meeting. In some cases, the initiation of a telecommunication session can occur in response to information received by a calendar access module 234, which can extract the logistical information for the selected meeting and provide this information to conferencing application 232. The conferencing application 232 that is used or accessed will correspond to the conferencing application hosting the user's selected upcoming (or in progress) telecommunication event, or to a more general or universal conferencing application that is compatible with the host system and can be triggered via an auto-connect module 240 that connects the user to the selected meeting using the received login information.

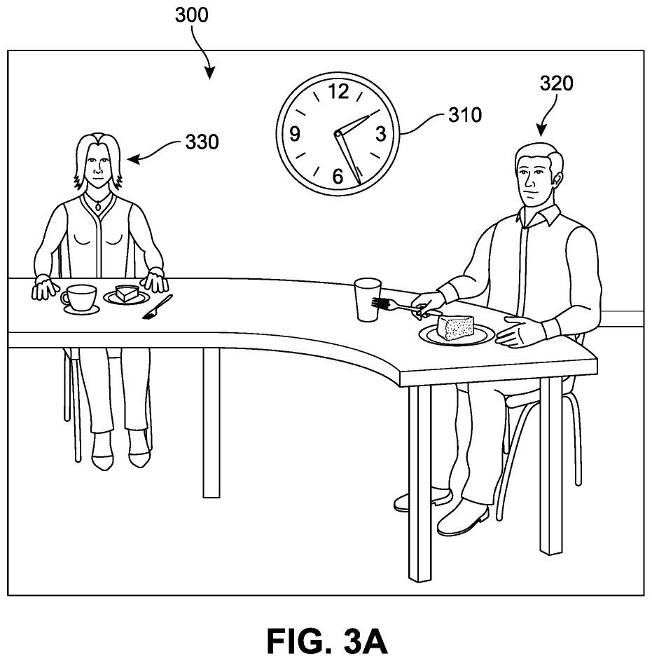

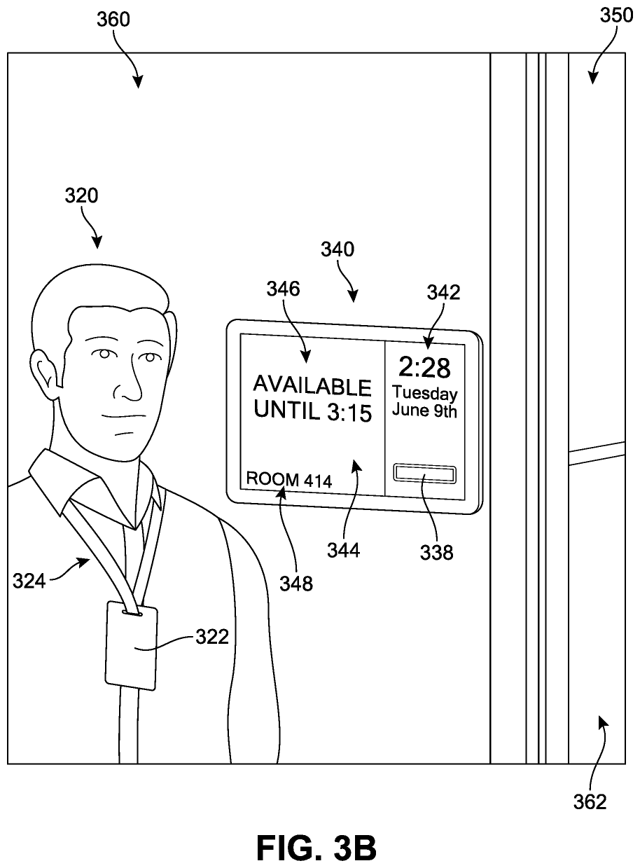

Referring now to FIGS. 3A-7, an example of one technical implementation of the proposed systems is presented. In FIG. 3A, two colleagues are having a meal in a break room 300. As a second user 320 and his colleague 330 share this time together, a clock 310 located on rear wall displays the time (here 2:26 pm). As shown next in FIG. 3B, the second user 320, having become aware that an upcoming meeting time is approaching, has left his meal and the break room 300, and made his way to an adjoining or nearby second conference room (“second room”) 350. The second user 320 is now shown standing outside the second room 350 next to an external wall 360 of the room, viewing a second device 340 associated with the second room 350. The second device 340 includes a display panel 344 that offers a native control in the form of a second meeting room user interface (“second interface”) 346. The second interface 346 in this example includes a main display window 348 identifying the room (“room 414”) and indicating a general availability of the conference room (“available until 3:15”). A secondary display window 342 shows the current time (“2:28 Tuesday June 9^{th}) as well as an actuatable option 338 to view additional information or access other options or settings. Thus, in this example, approximately two minutes have passed since the user departed the break room 300 of FIG. 3A. In other words, there has been a very short duration between the activity immediately preceding the second user's access of the second room 350.

As a general matter, a “native control” refers to a mechanism for communicating content through a client application to an application user. For example, native controls may include pop-up windows that may be presented to a user as software application user interfaces (UIs), interactive buttons, or other objects that may be shown to a user through native application UIs, as well as mechanisms that are native to a particular application for presenting associated content with those native controls. In different implementations, a native control can include any other type of user interface such as a dialog box, notification, alert, reminder, email, instant message, or other application communication or presentation means. In addition, a “trigger event” or “triggering event” refers to an event (or specific sequence of events) associated with a particular use of an application, which can correspond to a selection of an option offered via a native control, or an event that matches a condition. For example, the triggering event may be understood to include a ‘click’, toggle, or other input actions (such as a mouse left-button or right-button click, a touchscreen tap, a selection of data, or other input types).

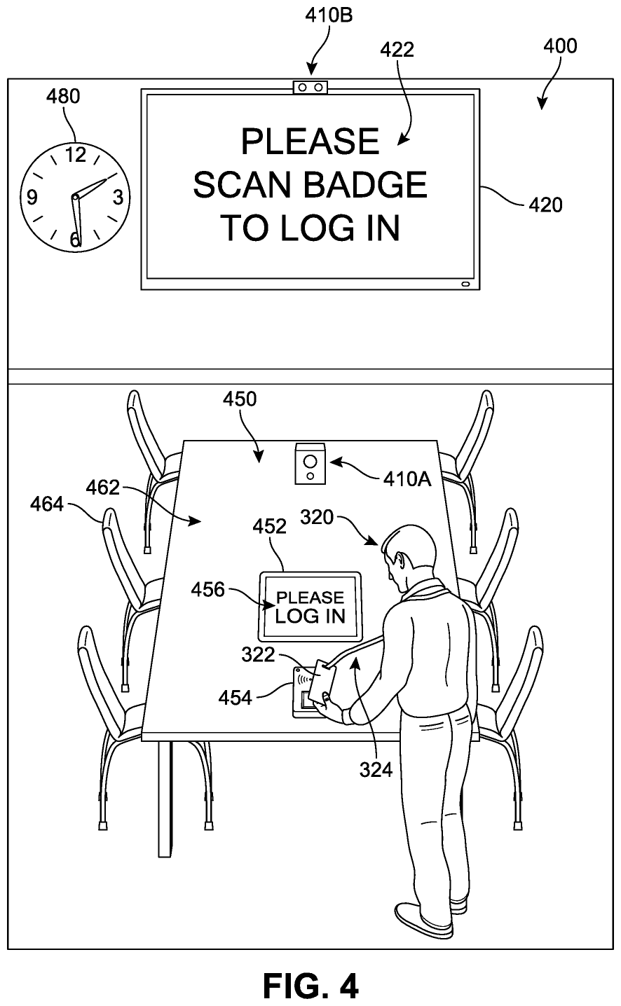

The second user 320 in FIG. 3B is also shown with a first identification badge (“first badge”) 322 worn on a lanyard 324 which includes a type of security token. Referring now to FIG. 4, as the second user 320 walks into the second room at approximately 2:28 pm (see a clock 480 installed on a wall 400), in some implementations, presentation of the first badge 322 to an RFID reader 454 can be configured to serve as a type of input to a second conference room management system (“second system”) 450. The second system 450 in this case is represented by a log-in device 452 providing an interface 456, as well as the RFID reader 454, and a large monitor 420 with a primary display 422. The system can also be understood to include the second interface 346 that was shown in FIG. 3B in some implementations. In FIG. 4, the second system 450 is located in or associated with the second room, where the room also includes a conference table 462, chairs 464, and audio-visual equipment (410A, 410B). In different implementations, the user input shown in FIG. 4 can serve as a triggering event in which the second system 450 automatically initiates a search through a database (such as an organization directory or other membership or account listing) to determine whether the information or code transmitted by the input corresponds to a user account or other type of user identity (see FIG. 2). Once the second system 450 locates a user account and/or profile matching the user input, and the user's identity has been verified, the second system 450 can be understood to have ‘registered’ or logged in the second user 320. In some implementations, the system can confirm for the second user 320 an ‘impromptu’ room booking for use of the second room at this time, at least until the start time of the next reservation time for this room. In some other implementations, the second system 450 can also access the second user's upcoming scheduled events and facilitate the user's conference connection experience.

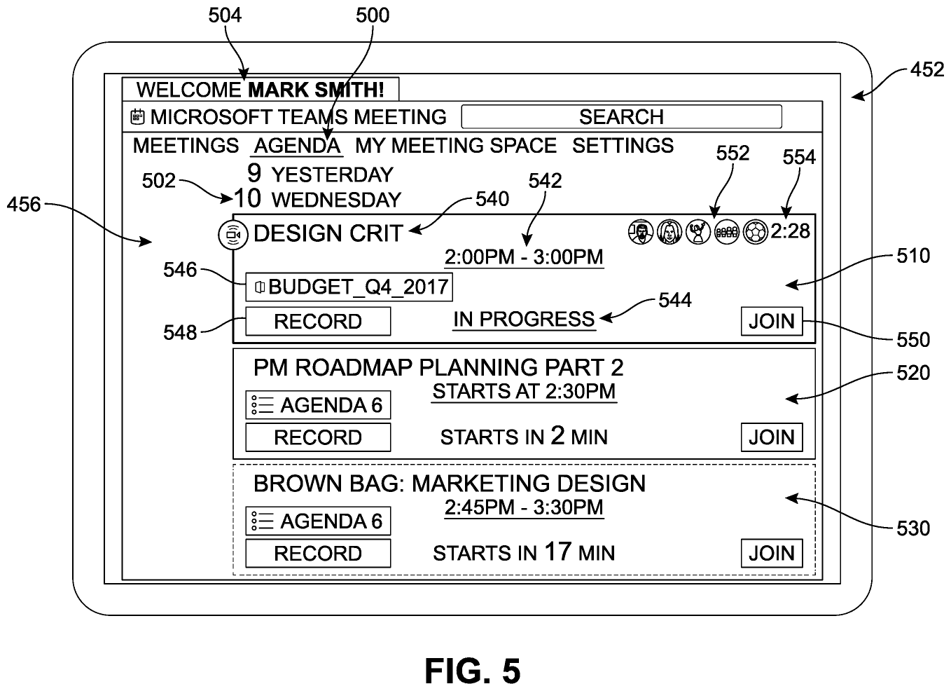

In different implementations, a user may review information for various meetings and events on a collaboration, calendar, or agenda component of a conferencing application. Referring to FIG. 5, an example of an agenda component 500 is shown on the interface 456 of the log-in device 452, specific for registered user 504. The agenda component 500 includes a calendar panel 502 that can be configured to present the various events or activities of interest to a user over a specified duration. In some implementations, there may also be a detailed view panel that can provide a space for additional information for an event to be displayed, or to provide various options for any of the meetings. This type of meeting management tool can include one or more of the technical solutions described herein.

The calendar panel 502 in this example includes a first indicator 510 for a first meeting, a second indicator 520 for a second meeting, and a third indicator 530 for a third meeting. Each indicator can be configured to display or present information specific to one event or activity. In FIG. 5, the indicators include a title or name 540 of the event, as well as its scheduled time 542, and accompanying information such as expected participants 552, a meeting status 544, a current time 554 for the time zone in which this meeting was scheduled. In some cases, there may be meeting materials that have been made available that can be viewed by selecting an attachment link (“Budget_Q4_2017”) 546. As shown herein, the meetings can be presented in order of their proximity to the current time.

With respect to the first indicator 510, it can be seen that the first meeting (“Design Crit”) is already in progress via the meeting status 544, and a selectable option 550 provides a “Join” function that may remain available prior to as well as throughout the duration of an ongoing meeting. Each meeting shown includes the Join option, by which the user can expressly choose to which meeting the second system should auto-connect.

A later meeting is represented by the second indicator 520 (“PM Roadmap Planning Part 2”) that has an upcoming start time. In addition, the third indicator 530 is directed to a third meeting (“Brown Bag: Marketing Design”) occurring at a later time. In other words, each meeting has a different start time. In some implementations, the second system can use this type of arrangement to remind the user of his or her meeting events, as well as various logistical details for each event that may help the user choose a meeting to be connected to.

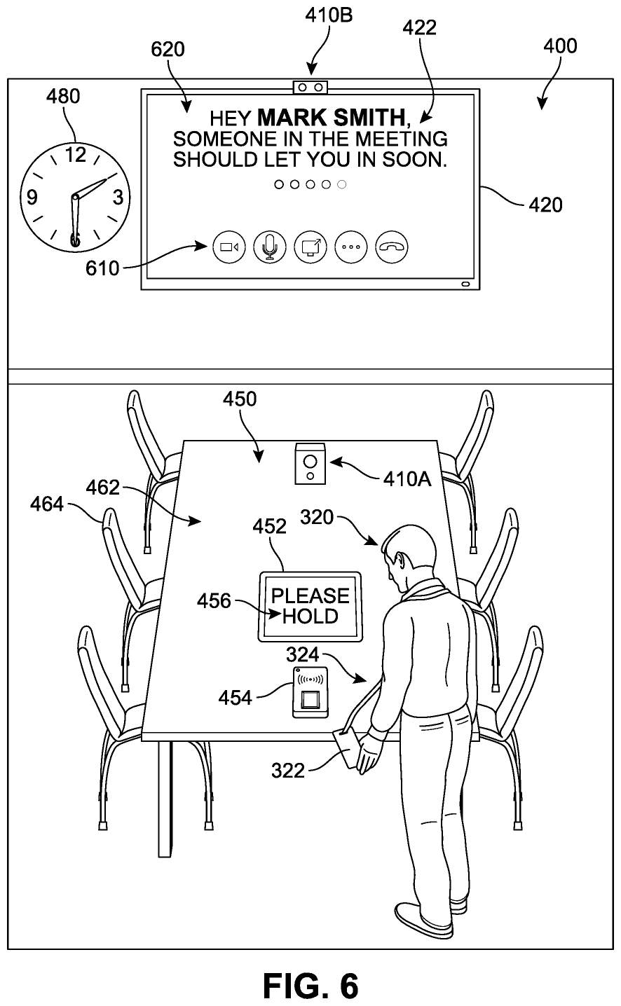

In FIG. 6, another minute has passed (as represented by 2:29 on the clock 480), and the user can be understood to have selected a meeting. For purposes of this example, the second user 320 has chosen the second meeting “PM Roadmap Planning Part 2” shown in FIG. 5 and which is scheduled to begin at 2:30 pm. Once the user has made his selection, the second system 450 can automatically initiate a communication with the appropriate teleconferencing software (“host system”) that was identified or was otherwise designated for this meeting, and attempt to open a telecommunications session between the second system 350 and the event host system. In other words, the second user 320 can be transitioned or conducted to the desired telecommunications session without further user input. Thus, in this example, the user has simply presented his identification badge, selected the desired meeting from a list of his scheduled meetings, and been moved seamlessly and effortlessly into the connection experience.

This new system state is reflected by a change on the display 456 of FIG. 6, which now asks that the second user 350 “Please Hold” while the monitor 420 on the wall 400 now includes a message 620 “Hey Mark Smith, someone in the meeting should let you in soon” on the primary display 422, as well as various selectable options 610 for adjusting communication settings and/or preferences. The message can confirm to the second user 320 that the session has been successfully initiated and that the organizer of the meeting has yet to join the meeting from the other end. It should be understood that any text shown in the examples throughout this application is for purposes of illustration only and can vary greatly, and/or may not be presented to a user at all.

With such an arrangement, the second user 320 is able to relax at this time, and perhaps choose where he wishes to sit or stand during the meeting, test the recording equipment 410A and 410B, review various information about the meeting, or make other modifications to his connection settings. In cases where the second user 320 is actually the meeting organizer, he may proceed with viewing the participants who have been logged in, reviewing various meeting logistics, and formally starting or ‘letting in’ participants to the meeting when ready.

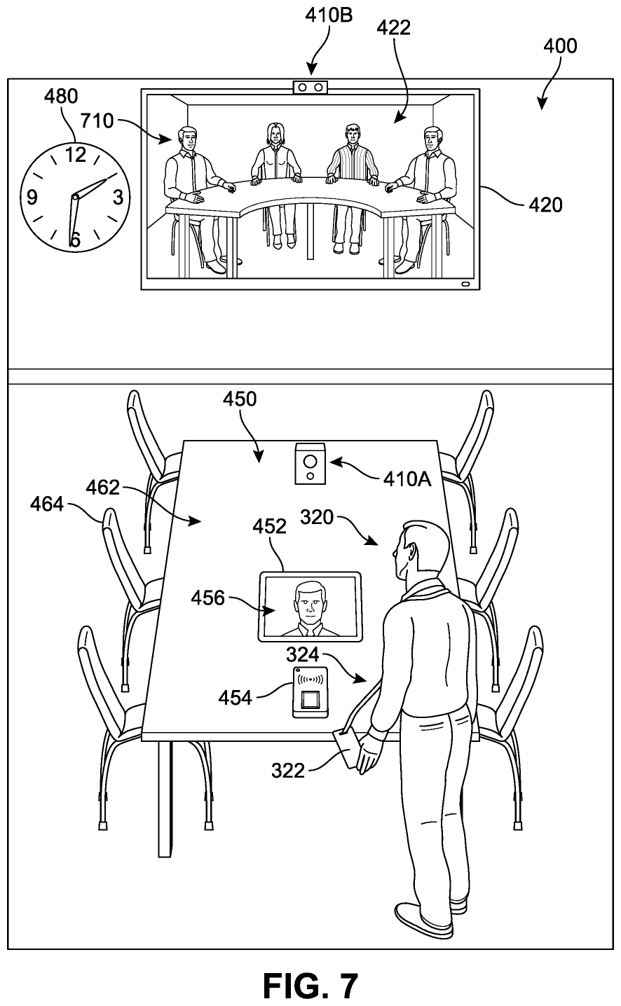

Once the organizer accepts or formally begins the meeting, the second user may be automatically joined to the selected meeting. In FIG. 7, at approximately 2:31 pm (see clock 480), an organizer has welcomed participants into the meeting, as reflected by a change on the display 456, which now shows the image of the second user 320 that is being recorded now (live or substantially live) for transmission to other participants, while the monitor 420 on the wall 400 now shows members of a host team 710 on the primary display 422. Thus, the meeting, having now begun, can be enjoyed by the second user 320, with minimal effort or anxiety having been associated with the connection process.

In different implementations, it can be appreciated that the selected meeting overlaps or otherwise conflicts with a prior reservation for the room. In other words, the selected meeting may have a duration that extends into a time frame in which the second room has been already booked. In such cases, the system can notify the second user of the conflict, either on the outside interface panel, or on one of the displays in the room. In some implementations, this notification can occur once the user makes his meeting selection. In response to determining that there is a conflict, the system can inform the user that the room is only available only until a specific time that occurs before the scheduled end of his selected meeting. The interface may then offer alternative room choices (if available). However, in some implementations, the second user may proceed with the use of the room for the time being. As a result, the second user may be given one or more warnings as the next reservation time approaches, and/or find himself ‘logged out’ when the next reservation time occurs. In other implementations, the system may remain ‘silent’ and allow the second user to discuss or coordinate the situation with the next user when the next user arrives. In another example, the second user may request that the system seamlessly move or transfer his current telecommunications session to a nearby room that is available at that time. In other implementations, the user may be able to override the previous reservation, as will be discussed with reference to FIGS. 9A-9C below.

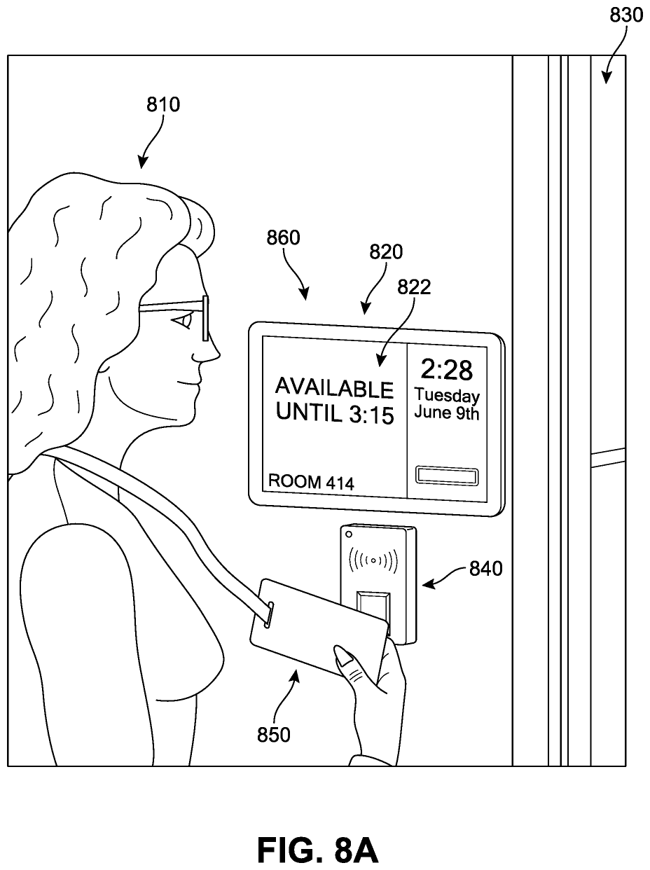

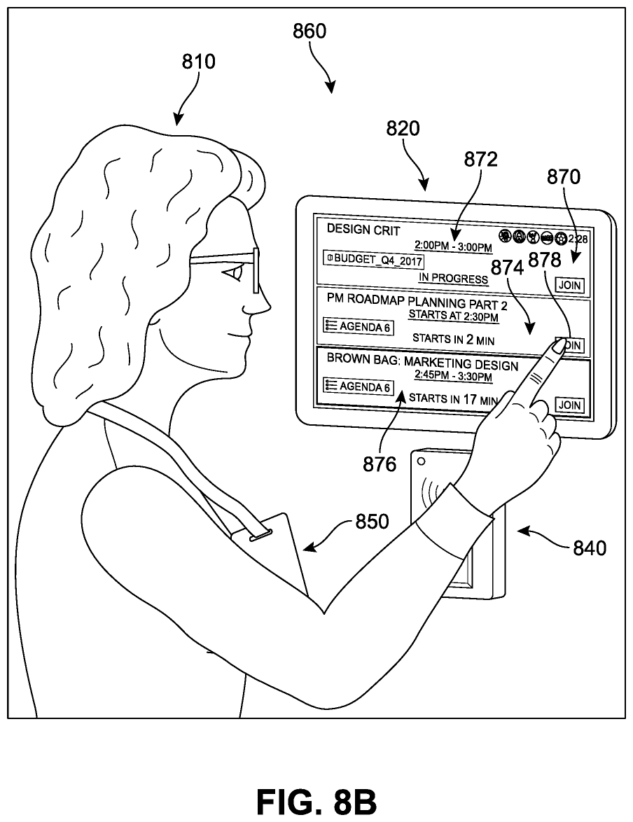

The proposed systems described herein can vary in different implementations. For example, in some cases, the log-in device can be disposed outside of the meeting room. This can allow a user to better determine whether a room currently available is suited for their upcoming meeting event. FIGS. 8A and 8B show one possible implementation of this, where a third user 810 has approached a third conference room (“third room”) 830 and is viewing a third device 820 associated with the third room 830. The third device 820 includes a display panel 822 that offers a native control in the form of a third meeting room user interface (“third interface”). At this time, the third interface simply displays room availability and other generalized information. However, in this case, the third device 820 is situated adjacent to or near an RFID reader 840, which is configured to read data of a second badge 850 presented by the third user 810. In other words, the devices discussed previously as facilitating room reservation and user account registration are now made available to users outside the conference room. In some implementations, the third device 820 can be understood to serve as both the room information display and the interface for a third conference room management system (“third system”) 860 designated management of for this room.

Referring now to FIG. 8B, the third user 810, having logged in and been authenticated by the third system 860, is now able to view her schedule 870 for the next few hours, including a first event 872, a second event 874, and a third event 876. In this example, the third user 810 is opting to join the second event 874 by selection of a “Join” option 878. As described earlier with respect to FIGS. 5-7, in different implementations, in response to this selection, the third system 860 can automatically initiate a communication with the appropriate teleconferencing software (“host system”) that was identified or was otherwise designated for this meeting, and attempt to open a telecommunications session between the third system 860 and the event host system. In other words, prior to walking into the conference room, the third user 810 can be assured that the room is available and ready for use for the full duration of the selected meeting. As she makes her way into the third room 830, there will be little or no delay as she is conducted to the desired telecommunications session (e.g., with no further user input). Thus, in this example, the user has simply approached the external display panel of the conference room, presented her identification badge, selected the desired meeting from a list of her scheduled meetings, confirmed availability of this room for her event and ensured that the room now identifies itself as being “booked” or “reserved” during this period, and moved seamlessly and effortlessly into her connection experience.

In FIG. 9A, a similar scenario is presented, whereby a fourth user 910 approaches a fourth device 922 associated with a fourth conference room (“fourth room”) 940. As she attempts to log in via RFID reader 960 and badge 930, the fourth user 910 notes that the room is actually booked (previously reserved) at this time. She reviews the information on display 922 and recognizes that this reservation began at 2:00 pm, yet the fourth room 940 remains empty. She is able to assess this situation on-site, realizing that by the current time of 2:28 pm (as shown on the display 922) the room should have been in use by someone if the reservation was maintained. Referring next to FIG. 9B, rather than find herself barred from accessing and enjoying this resource due to the prior (apparently defunct) reservation, the fourth user 910 observes that there is no one using the room and so opts to proceed with her own use of the room. She presents her badge 930 to the system and, as shown in FIG. 9C, is promptly given access to the room for her own use, as reflected by a message 924 “Override Access Granted”. The fourth user 910 can move to the next steps via a selectable option 926 which can now guide her to selection and/or auto-connection to her own meeting event that is about to begin or is in progress. Thus, in different implementations, the system may allow users who wish to engage in impromptu or ‘walk-up’ room use to override previous room reservations in cases where no use of the room is actually occurring during the reservation period. This policy can be adjusted to accommodate different minimum waiting periods (e.g., wait at least 15 minutes before permitting another user to override), require specific user levels (e.g., director, manager, etc.), or be subject to other conditions or settings.

In some other implementations, the proposed system can include provisions for verifying the scheduled use of a room (i.e., is usage of this space actually occurring in real-time?) by making reference to room occupancy or motion sensors and/or by reference to user-to-user communications, user location tracking, access to information about personnel calendars that can indicate sick days or vacation days, calendar conflicts, or other such data. For example, a sensor may detect an activity of a user within the meeting space. The detected activity may be a motion, a sound, a connection of a client device to a communal meeting device, as a few examples. The sensor(s) can be configured to determine whether the meeting space is associated with a scheduled meeting that intersects with a first time period (when the meeting is scheduled), where the first time period starts with the detected activity and ends based on a default time period, pre-set time slots, and a start time of a next scheduled meeting within the meeting space. In some implementations, a sensor may be configured to monitor activity of users within the meeting space, throughout the first time period, and may delete or extend the meeting room reservation based on whether activity within the meeting space is detected throughout and upon the expiration of the first time period. In other words, in one implementation, real-time usage of a resource can be ascertained and used to automatically update the booking system. This can increase confidence that usage of an organization's space or resource can be maximized at all times.

It may be appreciated that organizations may wish to increase or supplement the security process through which registration of a user occurs. For purposes of simplicity, the examples described above only depicted simple single-factor authentication (SFA), where the user simply presented an identification badge or token in order to obtain access to the room reservation management system. However, in many cases, additional steps or inputs may be required to better protect both the user's credentials and the resources the user can access. As one example, two-factor authentication (2FA), sometimes referred to as two-step verification or dual factor authentication, may be incorporated by the system to verify user identities. Two-factor authentication often provides a higher level of assurance than authentication methods that depend on SFA.

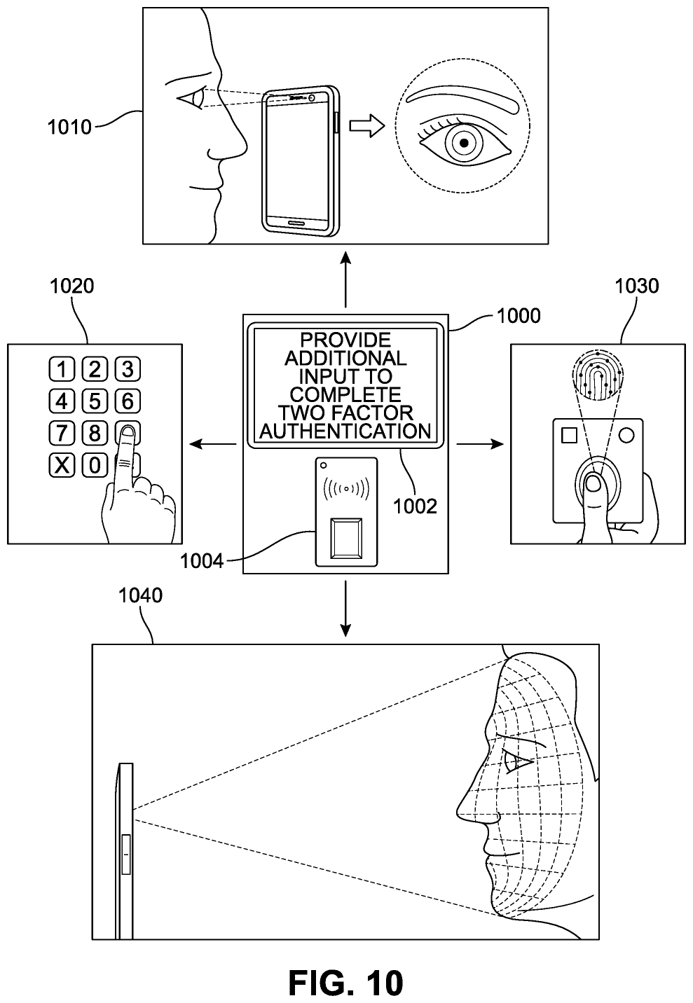

Referring to FIG. 10, in different implementations, the system can include a 2FA process that can include authentication methods in which users provide a first factor as well as a second factor. These factors can comprise possession factors or a security token (i.e., connected, disconnected, or contactless tokens), knowledge factors such as a password 1020, and inherence or biometric factors such as an eye scan 1010, fingerprint 1030, or facial scan 1040. Two-factor authentication adds an additional layer of security to the authentication process, which can decrease the likelihood of unauthorized users gaining access to an organization's devices or user accounts, because in such cases possession of the security token alone is not enough to pass the authentication check.

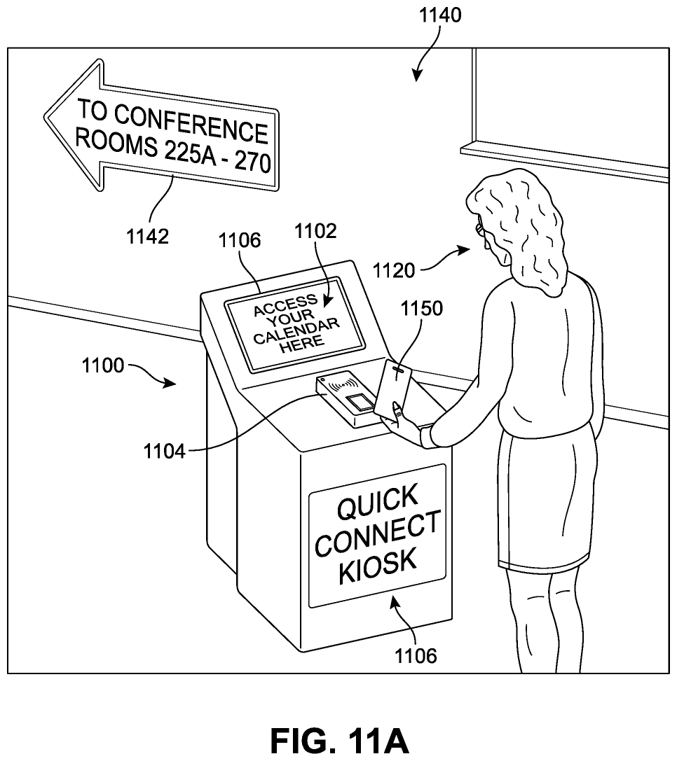

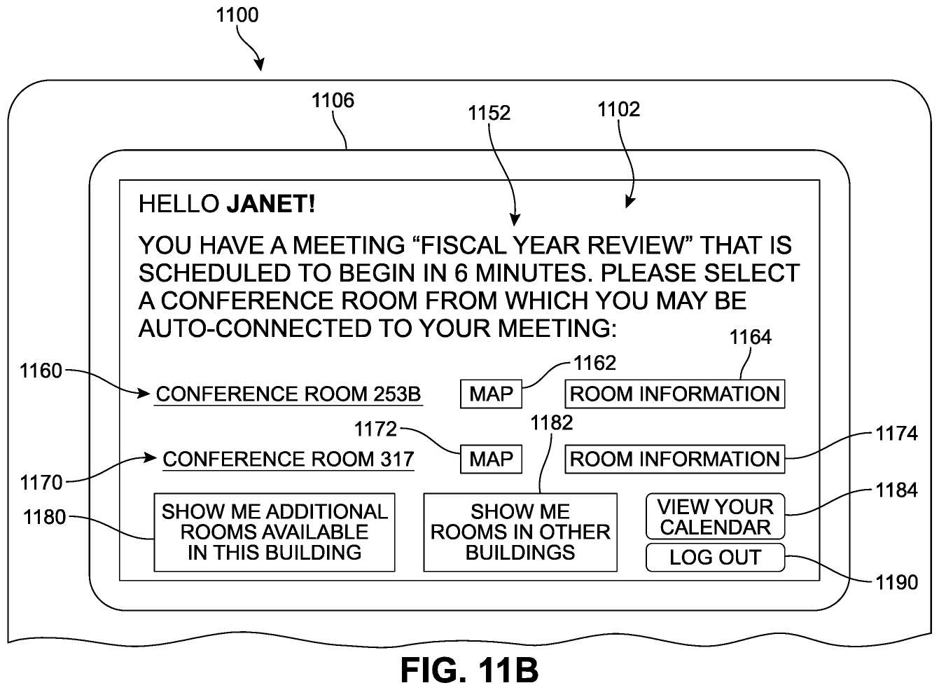

Although the examples described herein have shown users directly approach specific conference rooms, it should be understood that in different implementations, users may be able to register and/or select resources in a more broad or general manner. As one example, the system can include provisions for facilitating a user's experience by offering an overview of currently available resources, as well as provide the user with access to the user's own calendar from a public access site. Referring to FIGS. 11A and 11B, a fifth user 1120 is shown approaching a kiosk 1106 that is connected to a fifth conference room management system (“fifth system”) 1100. In some implementations, the kiosk 1106 can be placed or made available at any location in a building and/or outside, and can also be provided at multiple sites for ease of access. In some cases, there may be a plurality of kiosks located adjacent to one another in one area to allow many users to log in simultaneously if needed. It should be understood that while this scenario depicts a standalone kiosk with the primary function of providing users access to the conference room management system, in other implementations there may be more generic devices or portals that can be offered that serve multiple functions, including those described herein.

As the fifth user 1120 presents a badge 1150 to an RFID reader 1104 at the kiosk 1106, a display with an interface 1102 indicates to the user that they may access their calendar here. Furthermore, a sign 1142 (“To Conference Rooms 225A-270) on a nearby wall 1140 informs users that there are conference rooms in the vicinity, which can serve as a guide for users seeking access to public resources. In FIG. 11B, the fifth user has logged in to the fifth system 1100, and the display now presents a message 1152 via the interface 1102 for the user, who has been identified as Janet (‘Hello Janet! You have a meeting “Fiscal Year Review” that is scheduled to begin in 6 minutes. Please select a conference room from which you may be auto-connected to your meeting’).

Below the message 1152, a listing of available or suggested rooms is shown to the user, including a first room option 1160 and a second room option 1170. In different implementations, the interface 1102 can include provisions for offering the user further information or details that may help them make a selection that may be better suited to their needs and/or a location guide to the room. For example, the first room option 1160 includes a first map link 1162 as well as a first room information button 1164, and the second room option 1170 includes a second map link 1172 as well as a second room information button 1174.

In some cases, a user may not be satisfied with the options shown, or may have specific reasons or needs associated with their particular meeting or physical access. The system may, in some implementations, be configured to provide additional or alternate room reservation options. For example, in FIG. 11B, a user may select a first option 1180 to “Show me additional rooms available in this building” and a second option 1182 to “Show me rooms in other buildings”. In cases where the user wishes to connect or reserve a room for a meeting event other than the one that was identified in the message 1152, a third option 1184 to “View your calendar” may be selected and provide the user with an agenda interface similar to that described in the figures above. A Log Out option 1190 can also be offered in some implementations. It should be understood that the specific options or wording shown in the drawings is for purposes of illustration only, and that other types of native controls, interfaces, and options can be presented by the system to provide quick or impromptu room reservation utilities and auto-connections to user meetings.

Once the user selects their desired room, the room may become automatically booked for the duration of the user's selected or soonest upcoming meeting. In some implementations, the interface 1102 may show the user a map with directions to the conference room. When the user arrives at the selected room, the system can automatically initiate a connection to the telecommunications session. For example, upon arrival, the user may enter a password or present their security token to the room device(s), and in response to this input, the system can join or connect the room device(s) with the host system on behalf of the user. In some implementations, the room can include a room status display (for example, on an outside wall), and this display will have been updated to reflect the new reservation that has been made by the current user.

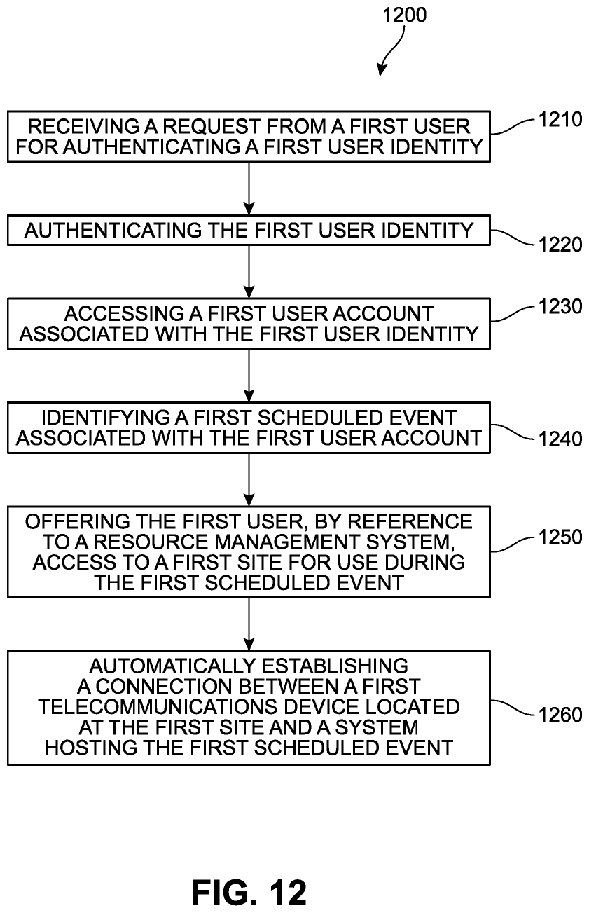

FIG. 12 is a flow chart illustrating an implementation of a method 1200 of managing the automatic room reservation and connection of a user to a conference event, as performed by a data processing system. In FIG. 12, a first step 1210 includes receiving, from a first user, a request for authenticating a first user identity based (at least) on a first authentication input. In a second step 1220, the method 1200 includes authenticating, based (at least) on access to a user database and the first authentication input, the first user identity. A third step 1230 includes accessing a first user account associated with the first user identity, and a fourth step 1240 includes identifying (at least) a first scheduled event in which the first user account is designated as a potential attendee. In a fifth step 1250, the method involves offering the first user, by reference to a resource management system, access to a first resource space for use during the first scheduled event, the first resource space including a first telecommunications device. In addition, a sixth step 1260 includes automatically establishing a connection between the first telecommunications device and a system hosting the first scheduled event.

In other implementations, the method can include additional or alternate steps. For example, in some implementations, the first authentication input can be one of a security token, inherence factor, or password, as discussed above. In another example, the method also includes identifying a second scheduled event in which the first user account is designated as a potential attendee, and then determining that the first scheduled event occurs earlier in time than the second scheduled event. In such cases, automatically establishing a connection between the first telecommunications device and a system hosting the first scheduled event can be in response to the determination that the first scheduled event occurs earlier in time than the second scheduled event.

As another example, the method may also include identifying a second scheduled event in which the first user account is designated as a potential attendee, presenting, to the first user, the first scheduled event and the second scheduled event as selectable options, and receiving, from the first user, a request to join the first scheduled event. In such cases, automatically establishing a connection between the first telecommunications device and a system hosting the first scheduled event may be in response to receiving the request to join the first scheduled event. In some implementations, the request for authenticating a first user identity occurs while the first user is in the first resource space, while in other implementations the request for authenticating a first user identity is received via a computing device that is associated with the first resource space and is located in close proximity to the first resource space.

In some other examples, the request for authenticating a first user identity is received via a public kiosk that is located outside of the first resource space. The method may then also include presenting a listing of available resource spaces on an interface of the computing device, the listing including the first resource space, and receiving a selection, from the first user, of the first resource space. In another implementation, the method may include the system generating or creating a reservation, for the first user, of the first resource space for at least the duration of the first scheduled event. In some implementations, the method also includes accessing a resource space usage history for the first user, and automatically implementing connection settings that are in accordance with one or more preferences of the first user as indicated by the resource space usage history. In some implementations, authenticating the first user identity occurs as a result of a radio-frequency identification reading of the first authentication input, and in other implementations, authenticating the first user identity occurs as a result of a near field communication established between the first authentication input and a near field communication reader.

As a general matter, an example system for management of conference calls can include a conference server (which in some implementations can include more than one server). The server can be located in multiple geographic areas. In addition, the conference server can be connected, often through a firewall, to a wide area network (WAN), such as the Internet. The WAN can be coupled to and accessed through either a wired connection or a wireless local area network (WLAN) that can feature a wireless access point that operates, for example, in accordance with one of the IEEE 802.11 specifications.

In some implementations, the conference server can also be connected to a public switched telephone network (PSTN) via direct inward dialing (DID) trunks or primary rate interface (PRI) trunks. The conference server can also communicate, often through a relay, with a public land mobile network (PLMN), which can also be referred to as a wireless wide area network (WWAN) or a cellular network. In some cases, the PLMN can be configured to be interconnected with or integrated into the PSTN.

In addition, the system can include a number of electronic devices, such as mobile devices and stationary devices. These can include for example, a cellular phone, a smartphone, a tablet, a netbook, a laptop, a PDA (personal digital assistant), or any other device enabled for wireless communication. A mobile device can be equipped for cellular communications through the PLMN, for communications over WAN (accessed, for example, through WLAN by connecting via Wi-Fi to wireless access points) or it can be a dual-mode device capable of both cellular and WAN/WLAN communications. Cellular communications through the PLMN can include voice communications and data communications, and mobile device can support either or both these communication channels.

A mobile device can also include one or more radio transceivers and associated processing hardware and software to enable wireless communications with PLMN, and/or a WLAN via a wireless access point. In different implementations, the PLMN and a mobile device may be configured to operate in compliance with any one or more of a number of wireless protocols, including GSM, GPRS, CDMA, EDGE, UMTS, EvDO, HSPA, 3GPP, LTE, or a variety of others. In addition, a mobile device can roam within PLMN and across PLMNs, in a known manner, as its user moves. In some instances, a dual-mode mobile device and/or the conference server may be configured to facilitate roaming between PLMN and wireless access points, and are thus capable of seamlessly transferring sessions (such as voice calls) from a connection with the cellular interface of a dual-mode device (i.e., mobile device) to a WLAN interface of the dual-mode device, and vice versa.

There may also be a relay that serves to direct communications received over PLMN from a device to the conference server. The relay can also direct communications from the conference server to the mobile device via PLMN. Furthermore, in another implementation, a telephone set (such as a conventional landline telephone) can communicate with the conference server through PSTN.

In different implementations, the conference server can be implemented on one or more servers having suitable communications interfaces for connecting to and communicating with other system components. The conference server can include one or more processors, a memory, and a data interface. The processor(s) can be a single or multiple microprocessors, field programmable gate arrays (FPGAs), or digital signal processors (DSPs) capable of executing particular sets of instructions. Computer-readable instructions can be stored on a tangible non-transitory computer-readable medium, such as a flexible disk, a hard disk, a CD-ROM (compact disk-read only memory), and MO (magneto-optical), a DVD-ROM (digital versatile disk-read only memory), a DVD RAM (digital versatile disk-random access memory), or a semiconductor memory.

In some implementations, a memory stores user-profile or account information and user preferences for one or more users. The user-profile information can include, for example, a user's name, email address, location data, place of employment, home address, or the like. In addition, the user-profile information can include device information for one or more electronic devices (e.g., one or more mobile or computing devices and/or one or more telephone sets) associated with a user. Device information can include device's phone number (e.g., a cellular phone number or a landline number), a personal identification number (PIN), an IP address, if available, and so forth. In some embodiments, some or all of the user-profile information, including device information, can be retrieved, by the conference server, from the electronic devices. For example, if user-information for a particular electronic device includes device information only for one device associated with the user, and the device information includes only the IP address of the device, the conference server can use the IP information to communicate with the electronic device, for example, via WAN. The conference server can then retrieve from the electronic device additional device information for the device itself (e.g., a cellphone number associated with the device) and/or device information for other electronic devices associated with the same user (e.g., a landline number of the user's telephone set).

In one implementation, the conference server implements the switching to connect session legs and provides the conversion between, for example, a circuit-switched call and a VoIP call, or to connect legs of other media sessions. In some embodiments, in the context of voice calls, the conference server provides a number of additional functions including an automated attendant, interactive voice responses, call forwarding, conference call, or other such features. It can also implement certain usage restrictions on enterprise users, such as blocking international calls or toll free calls. In many embodiments, Session Initiation Protocol (SIP) can be used to set-up, manage, and terminate media sessions for voice calls. Other protocols can also be employed by the conference server, such as Web Services, Computer Telephony Integration (CTI) protocol, Session Initiation Protocol for Instant Messaging and Presence Leveraging Extensions (SIMPLE), and various custom Application Programming Interfaces (APIs).

The use of the disclosed systems and methods can enable users to review information for a conference at multiple points prior to the meeting time, and be presented an option to be auto joined to said conference during this review. In other words, in conjunction with their viewing of information for said conference, a user can readily opt to be automatically connected to the conference at a time specified for the conference. For example, as a user creates a meeting and its corresponding invitation, while a user views an invitation for the meeting, when a user RSVPs (or changes their RSVP) for the meeting, during any meeting notifications, meeting indicators, meeting “toasts” or pop-up messages, e-mail communications from the system or other users about the meeting, meeting preparation communications, or meeting objects can provide instances in which a user can be presented with an option to auto-join the meeting, making the process highly convenient and relevant. The ability to deliberately select this option for individual meetings at a time of their choosing, offers a wide range of benefits to users. This feature substantially reduces the time needed to prepare for user participation in the meeting, and the aggravation of being auto-joined to all meetings because of a setting that was modified previously for another meeting or forgetting to change one's general settings to auto-join scan various items. Furthermore, users are offered a straightforward means by which to implement their preferences for participating in a meeting, and the ability to easily change one's mind about the means of connecting to the meeting at multiple opportunities leading up to the meeting.

For the sake of simplicity of description, details are not provided herein for performing various connection processes and the configuration of different telecommunication components and user authentication. Implementations of the present disclosure can make use of any of the features, systems, components, devices, and methods described in U.S. Patent Publication Number 2009/0319916 to Gudipaty et al., published Dec. 24, 2009 and entitled “Techniques to auto-attend multimedia conference events,”; U.S. Patent Publication Number 2012/0275349 to Boyer et al., published Nov. 1, 2012 and entitled “Conference call monitoring with automatic reconnect”; U.S. Patent Publication Number 2017/0302718 to Ananthanarayanan et al., published Oct. 19, 2017 and entitled “Dynamic recording of online conference”; U.S. Patent Publication Number 2013/0144603 to Lord et al., published Jun. 6, 2013 and entitled “Enhanced voice conferencing with history”; U.S. Patent Publication Number 2011/0267419 to Quinn et al., published Nov. 3, 2011 and entitled “Accelerated instant replay for co-present and distributed meetings”; U.S. Patent Publication Number 2011/0249954 to Meek et al., published Oct. 13, 2011 and entitled “Capturing presentations in online conferences”; U.S. Patent Publication Number 2014/0362979 to Kaplan et al., published Dec. 11, 2014 and entitled “Catching up with an ongoing conference call”; U.S. Patent Publication Number 2010/0246448 to Krantz et al., published Sep. 30, 2010 and entitled “Automatic utilization of resources in a realtime conference”; U.S. Patent Publication Number 20120297229 to Desai et al., published on Nov. 22, 2012 and entitled “Auto-connect in a peer-to-peer network”; U.S. Patent Publication Number 2016/0373490 to Sedar et al., published on Dec. 22, 2016 and entitled “Automatic equipment configuration for meetings”; U.S. Patent Publication Number 2006/0047545 to Kumar et al., published on Mar. 2, 2006, and entitled “RFID server internals design”; U.S. Patent Publication Number 2011/0227704 to Padmanabhan et al., published on Sep. 22, 2011 and entitled “Rfid-based enterprise intelligence”; U.S. Patent Publication Number 2010/0030695 to Chen et al., published on Feb. 4, 2010 and entitled “Mobile device security using wearable security tokens”; and U.S. Patent Publication Number 2013/0251216 to Smowton et al., published on Sep. 26, 2013 and entitled “Personal Identification Combining Proximity Sensing with Biometrics”; as well as each of their disclosed methods and systems for the management of meetings, connection to and recording of conferences, user authentication, and so forth, the disclosures of each of which are herein incorporated by reference in their entirety.

In addition, implementations of the present disclosure can make use of any of the features, systems, components, devices, and methods described in U.S. Patent Publication Number 2018/0253666 to Fix, published Sep. 6, 2018 and entitled “Automatic reservation of meeting space through communal meeting device”; U.S. Patent Publication Number 2016/0180259 to Marianko et al., published Jun. 23, 2016 and entitled “Real-time Automatic Meeting Room Reservation Based on the Number of Actual Participants”; U.S. Patent Publication Number 2015/0186850 to Ramji, published Jul. 2, 2015 and entitled “Smart Meeting Creation and Management”; U.S. Patent Publication Number 2009/0299807 to Schiller et al., published on Dec. 3, 2009 and entitled “Scheduling opportunity previewer”; U.S. Patent Publication Number 2017/0308866 to Dotan-Cohen et al., published on Oct. 26, 2017 and entitled “Meeting Scheduling Resource Efficiency”; U.S. Pat. No. 7,707,256 to Rollin et al., issued on Apr. 27, 2010 and entitled “Suggesting meeting locations for conducting meetings”; U.S. Pat. No. 9,578,461 to Benzatti et al., issued on Feb. 21, 2017 and entitled “Location context, supplemental information, and suggestions for meeting locations”; U.S. Pat. No. 9,760,870 to Nortan et al., issued on Sep. 12, 2017 and entitled “Systems and methods for scheduling events”; U.S. Patent Publication Number 2015/0058425 to Nathan et al., published on Feb. 26, 2015 and entitled “Smart meeting service”; U.S. Patent Publication Number 2008/0133282 to Landar et al., published on Jun. 5, 2008 and entitled “Meeting resource scheduling based upon attendance participation types”; U.S. Patent Publication Number 2012/0078676 to Adams et al., published on Mar. 29, 2012 and entitled “Meeting room scheduling system including room occupancy sensor and related methods”; U.S. Pat. No. 8,041,586 to Jethani et al., issued on Oct. 18, 2011 and entitled “Shared space availability by dynamically responding to user utilization behavior of saved space”; U.S. Pat. No. 7,693,736 to Chu et al., issued on Apr. 6, 2010 and entitled “Recurring meeting schedule wizard”; and U.S. Pat. No. 9,626,660 to Bathiya et al., issued on Apr. 18, 2017 and entitled “Conflict management in scheduling meetings”; as well as each of their disclosed methods and systems for the management of meetings and room reservations and so forth, the disclosures of each of which are herein incorporated by reference in their entirety.

The detailed examples of systems, devices, and techniques described in connection with FIGS. 1-12 are presented herein for illustration of the disclosure and its benefits. Such examples of use should not be construed to be limitations on the logical process implementations of the disclosure, nor should variations of user interface methods from those described herein be considered outside the scope of the present disclosure. In some implementations, various features described in FIGS. 1-12 are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations, and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a particular processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In implementations in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across a number of machines. Processors or processor-implemented modules may be located in a single geographic location (for example, within a home or office environment, or a server farm), or may be distributed across multiple geographic locations.

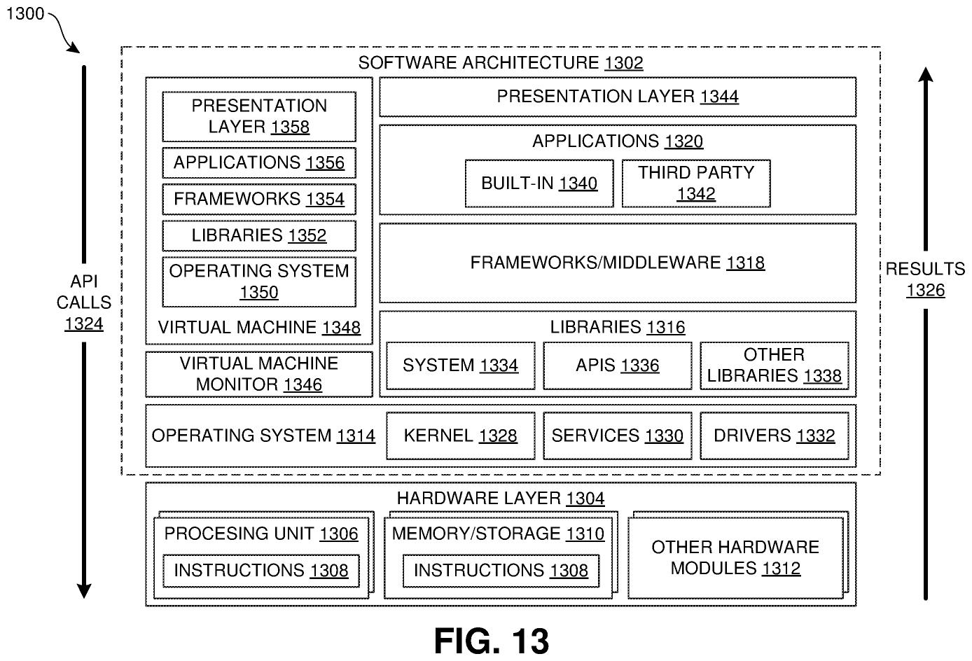

FIG. 13 is a block diagram 1300 illustrating an example software architecture 1302, various portions of which may be used in conjunction with various hardware architectures herein described, which may implement any of the above-described features. FIG. 13 is a non-limiting example of a software architecture and it will be appreciated that many other architectures may be implemented to facilitate the functionality described herein. The software architecture 1302 may execute on hardware that includes, among other things, document storage, processors, memory, and input/output (I/O) components. A representative hardware layer 1304 is illustrated and can represent, a computing device. The representative hardware layer 1304 includes a processing unit 1306 and associated executable instructions 1308. The executable instructions 1308 represent executable instructions of the software architecture 1302, including implementation of the methods, modules and so forth described herein. The hardware layer 1304 also includes a memory/storage 1310, which also includes the executable instructions 1308 and accompanying data. The hardware layer 1304 may also include other hardware modules 1312. Instructions 1308 held by processing unit 1308 may be portions of instructions 1308 held by the memory/storage 1310.

The example software architecture 1302 may be conceptualized as layers, each providing various functionality. For example, the software architecture 1302 may include layers and components such as an operating system (OS) 1314, libraries 1316, frameworks 1318, applications 1320, and a presentation layer 1344. Operationally, the applications 1320 and/or other components within the layers may invoke API calls 1324 to other layers and receive corresponding results 1326. The layers illustrated are representative in nature and other software architectures may include additional or different layers. For example, some mobile or special purpose operating systems may not provide the frameworks/middleware 1318.

The OS 1314 may manage hardware resources and provide common services. The OS 1314 may include, for example, a kernel 1328, services 1330, and drivers 1332. The kernel 1328 may act as an abstraction layer between the hardware layer 1304 and other software layers. For example, the kernel 1328 may be responsible for memory management, processor management (for example, scheduling), component management, networking, security settings, and so on. The services 1330 may provide other common services for the other software layers. The drivers 1332 may be responsible for controlling or interfacing with the underlying hardware layer 1304. For instance, the drivers 1332 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 1316 may provide a common infrastructure that may be used by the applications 1320 and/or other components and/or layers. The libraries 1316 typically provide functionality for use by other software modules to perform tasks, rather than rather than interacting directly with the OS 1314. The libraries 1316 may include system libraries 1334 (for example, C standard library) that may provide functions such as memory allocation, string manipulation, file operations. In addition, the libraries 1316 may include API libraries 1336 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 1316 may also include a wide variety of other libraries 1338 to provide many functions for applications 1320 and other software modules.

The frameworks 1318 (also sometimes referred to as middleware) provide a higher-level common infrastructure that may be used by the applications 1320 and/or other software modules. For example, the frameworks 1318 may provide various graphic user interface (GUI) functions, high-level resource management, or high-level location services. The frameworks 1318 may provide a broad spectrum of other APIs for applications 1320 and/or other software modules.

The applications 1320 include built-in applications 1340 and/or third-party applications 1342. Examples of built-in applications 1340 may include, but are not limited to, a contacts application, a browser application, a location application, a media application, a messaging application, and/or a game application. Third-party applications 1342 may include any applications developed by an entity other than the vendor of the particular platform. The applications 1320 may use functions available via OS 1314, libraries 1316, frameworks 1318, and presentation layer 1344 to create user interfaces to interact with users.

Some software architectures use virtual machines, as illustrated by a virtual machine 1348. The virtual machine 1348 provides an execution environment where applications/modules can execute as if they were executing on a hardware machine (such as the machine 1000 of FIG. 10, for example). The virtual machine 1348 may be hosted by a host OS (for example, OS 1314) or hypervisor, and may have a virtual machine monitor 1346 which manages operation of the virtual machine 1348 and interoperation with the host operating system. A software architecture, which may be different from software architecture 1302 outside of the virtual machine, executes within the virtual machine 1348 such as an OS 1350, libraries 1352, frameworks 1354, applications 1356, and/or a presentation layer 1358.

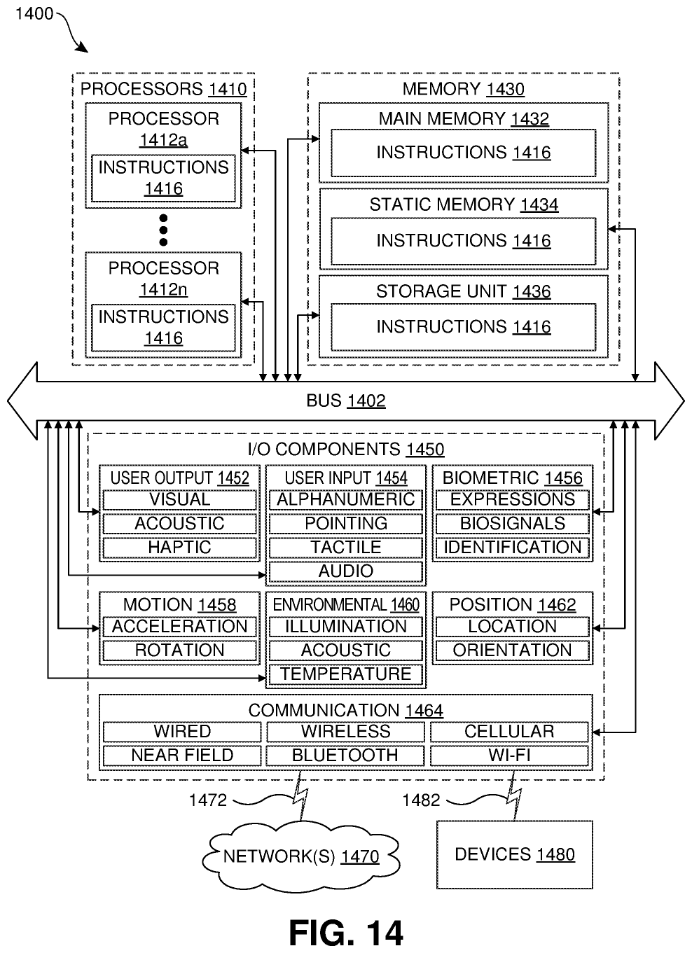

FIG. 14 is a block diagram illustrating components of an example machine 1400 configured to read instructions from a machine-readable medium (for example, a machine-readable storage medium) and perform any of the features described herein. It is to be understood that the phrase “machine-readable medium” and “computer-readable medium” are interchangeable in their usage herein. The example machine 1400 is in a form of a computer system, within which instructions 1416 (for example, in the form of software components) for causing the machine 1400 to perform any of the features described herein may be executed. As such, the instructions 1416 may be used to implement modules or components described herein. The instructions 1416 cause unprogrammed and/or unconfigured machine 1400 to operate as a particular machine configured to carry out the described features. The machine 1400 may be configured to operate as a standalone device or may be coupled (for example, networked) to other machines. In a networked deployment, the machine 1400 may operate in the capacity of a server machine or a client machine in a server-client network environment, or as a node in a peer-to-peer or distributed network environment. Machine 1400 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 1400 is illustrated, the term “machine” includes a collection of machines that individually or jointly execute the instructions 1416.

The machine 1400 may include processors 1410, memory 1430, and I/O components 1450, which may be communicatively coupled via, for example, a bus 1402. The bus 1402 may include multiple buses coupling various elements of machine 1400 via various bus technologies and protocols. In an example, the processors 1410 (including, for example, a central processing unit (CPU), a graphics processing unit (GPU), a digital signal processor (DSP), an ASIC, or a suitable combination thereof) may include one or more processors 1412a to 1412n that may execute the instructions 1416 and process data. In some examples, one or more processors 1410 may execute instructions provided or identified by one or more other processors 1410. The term “processor” includes a multi-core processor including cores that may execute instructions contemporaneously. Although FIG. 14 shows multiple processors, the machine 1400 may include a single processor with a single core, a single processor with multiple cores (for example, a multi-core processor), multiple processors each with a single core, multiple processors each with multiple cores, or any combination thereof. In some examples, the machine 1400 may include multiple processors distributed among multiple machines.

The memory/storage 1430 may include a main memory 1432, a static memory 1434, or other memory, and a storage unit 1436, both accessible to the processors 1410 such as via the bus 1402. The storage unit 1436 and memory 1432, 1434 store instructions 1416 embodying any one or more of the functions described herein. The memory/storage 1430 may also store temporary, intermediate, and/or long-term data for processors 1410. The instructions 1416 may also reside, completely or partially, within the memory 1432, 1434, within the storage unit 1436, within at least one of the processors 1410 (for example, within a command buffer or cache memory), within memory at least one of I/O components 1450, or any suitable combination thereof, during execution thereof. Accordingly, the memory 1432, 1434, the storage unit 1436, memory in processors 1410, and memory in I/O components 1450 are examples of machine-readable medium.

As used herein, “machine-readable medium” refers to a device able to temporarily or permanently store instructions and data that cause machine 1400 to operate in a specific fashion. The term “machine-readable medium,” as used herein, does not encompass transitory electrical or electromagnetic signals per se (such as on a carrier wave propagating through a medium); the term “machine-readable medium” may therefore be considered tangible and non-transitory. Non-limiting examples of a non-transitory, tangible machine-readable medium may include, but are not limited to, nonvolatile memory (such as flash memory or read-only memory (ROM)), volatile memory (such as a static random-access memory (RAM) or a dynamic RAM), buffer memory, cache memory, optical storage media, magnetic storage media and devices, network-accessible or cloud storage, other types of storage, and/or any suitable combination thereof. The term “machine-readable medium” applies to a single medium, or combination of multiple media, used to store instructions (for example, instructions 1416) for execution by a machine 1400 such that the instructions, when executed by one or more processors 1410 of the machine 1400, cause the machine 1400 to perform and one or more of the features described herein. Accordingly, a “machine-readable medium” may refer to a single storage device, as well as “cloud-based” storage systems or storage networks that include multiple storage apparatus or devices.

The I/O components 1450 may include a wide variety of hardware components adapted to receive input, provide output, produce output, transmit information, exchange information, capture measurements, and so on. The specific I/O components 1450 included in a particular machine will depend on the type and/or function of the machine. For example, mobile devices such as mobile phones may include a touch input device, whereas a headless server or IoT device may not include such a touch input device. The particular examples of I/O components illustrated in FIG. 14 are in no way limiting, and other types of components may be included in machine 1400. The grouping of I/O components 1450 are merely for simplifying this discussion, and the grouping is in no way limiting. In various examples, the I/O components 1450 may include user output components 1452 and user input components 1454. User output components 1452 may include, for example, display components for displaying information (for example, a liquid crystal display (LCD) or a projector), acoustic components (for example, speakers), haptic components (for example, a vibratory motor or force-feedback device), and/or other signal generators. User input components 1454 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 1450 may include biometric components 1456 and/or position components 1462, among a wide array of other environmental sensor components. The biometric components 1456 may include, for example, components to detect body expressions (for example, facial expressions, vocal expressions, hand or body gestures, or eye tracking), measure biosignals (for example, heart rate or brain waves), and identify a person (for example, via voice-, retina-, and/or facial-based identification). The position components 1462 may include, for example, location sensors (for example, a Global Position System (GPS) receiver), altitude sensors (for example, an air pressure sensor from which altitude may be derived), and/or orientation sensors (for example, magnetometers).

The I/O components 1450 may include communication components 1464, implementing a wide variety of technologies operable to couple the machine 1400 to network(s) 1470 and/or device(s) 1480 via respective communicative couplings 1472 and 1482. The communication components 1464 may include one or more network interface components or other suitable devices to interface with the network(s) 1470. The communication components 1464 may include, for example, components adapted to provide wired communication, wireless communication, cellular communication, Near Field Communication (NFC), Bluetooth communication, Wi-Fi, and/or communication via other modalities. The device(s) 1480 may include other machines or various peripheral devices (for example, coupled via USB).

In some examples, the communication components 1464 may detect identifiers or include components adapted to detect identifiers. For example, the communication components 1464 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 1462, such as, but not limited to, geo-location via Internet Protocol (IP) address, location via Wi-Fi, cellular, NFC, Bluetooth, or other wireless station identification and/or signal triangulation.

While various implementations have been described, the description is intended to be exemplary, rather than limiting, and it is understood that many more implementations and implementations are possible that are within the scope of the implementations. Although many possible combinations of features are shown in the accompanying figures and discussed in this detailed description, many other combinations of the disclosed features are possible. Any feature of any implementation may be used in combination with or substituted for any other feature or element in any other implementation unless specifically restricted. Therefore, it will be understood that any of the features shown and/or discussed in the present disclosure may be implemented together in any suitable combination. Accordingly, the implementations are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus the following claims are hereby incorporated into the Detailed Description, with each claim standing on its own as a separately claimed subject matter.

What is claimed is:

1. A system comprising:
a processor; and
computer readable media including instructions which, when executed by the processor, cause the processor to:
receive, from a first user, a request for authenticating a first user identity based on a first authentication input;
authenticate, based on access to a user database and the first authentication input, the first user identity;
access a first user account associated with the first user identity;
identify first scheduled event in which the first user account is designated as a potential attendee;
offer the first user, by reference to a resource management system, access to a first resource space for use during the first scheduled event, the first resource space including a first telecommunications device; and
automatically establish a connection between the first telecommunications device and a system hosting the first scheduled event.

2. The system of claim 1, wherein the first authentication input is one of a security token, inherence factor, or password.

3. The system of claim 1, wherein the instructions further cause the processor to:
identify a second scheduled event in which the first user account is designated as a potential attendee; and
determine that the first scheduled event occurs earlier in time than the second scheduled event;
wherein the connection between the first telecommunications device and the system hosting the first scheduled event is automatically established in response to the determination that the first scheduled event occurs earlier in time than the second scheduled event.

4. The system of claim 1, wherein the instructions further cause the processor to:
identify a second scheduled event in which the first user account is designated as a potential attendee;
present, to the first user, the first scheduled event and the second scheduled event as selectable options; and
receive, from the first user, a request to join the first scheduled event;
wherein the connection between the first telecommunications device and the system hosting the first scheduled event is automatically established in response to receiving the request to join the first scheduled event.

5. The system of claim 1, wherein the request for authenticating a first user identity occurs while the first user is in the first resource space.

6. The system of claim 1, wherein the request for authenticating a first user identity is received via a computing device that is associated with the first resource space and is located in or in close proximity to the first resource space.

7. The system of claim 1, wherein the request for authenticating a first user identity is received via a public kiosk that is located outside of the first resource space.

8. The system of claim 7, wherein the instructions further cause the processor to:
present a listing of available resource spaces on an interface of the public kiosk, the listing including the first resource space; and
receive a selection, from the first user, of the first resource space.

9. The system of claim 1, wherein the instructions further cause the processor to create a reservation, for the first user, of the first resource space for the duration of the first scheduled event.

10. The system of claim 1, wherein the instructions further cause the processor to:
access a resource space usage history for the first user; and
automatically implement connection settings that are in accordance with one or more preferences of the first user as indicated by the resource space usage history.

11. A method performed by a data processing system comprising:
receiving, from a first user, a request for authenticating a first user identity based on a first authentication input;
authenticating, based on access to a user database and the first authentication input, the first user identity;
accessing a first user account associated with the first user identity;
identifying a first scheduled event in which the first user account is designated as a potential attendee;
offering the first user, by reference to a resource management system, access to a first resource space for use during the first scheduled event, the first resource space including a first telecommunications device; and
automatically establishing a connection between the first telecommunications device and a system hosting the first scheduled event.

12. The method of claim 11, further comprising:
identifying a second scheduled event in which the first user account is designated as a potential attendee; and
determining that the first scheduled event occurs earlier in time than the second scheduled event;
wherein automatically establishing the connection between the first telecommunications device and the system hosting the first scheduled event is in response to the determination that the first scheduled event occurs earlier in time than the second scheduled event.

13. The method of claim 11, further comprising:
identifying a second scheduled event in which the first user account is designated as a potential attendee;
presenting, to the first user, the first scheduled event and the second scheduled event as selectable options; and
receiving, from the first user, a request to join the first scheduled event;
wherein automatically establishing the connection between the first telecommunications device and the system hosting the first scheduled event is in response to receiving the request to join the first scheduled event.

14. The method of claim 11, wherein the request for authenticating a first user identity is received via a computing device that is associated with the first resource space and is located in or in close proximity to the first resource space.

15. The method of claim 11, further comprising:
presenting a listing of available resource spaces on an interface of a public kiosk, the listing including the first resource space; and
receiving a selection, from the first user, of the first resource space.

16. The method of claim 11, further comprising creating a reservation, for the first user, of the first resource space for the duration of the first scheduled event.

17. The method of claim 11, further comprising:
accessing a resource space usage history for the first user; and
automatically implementing connection settings that are in accordance with one or more preferences of the first user as indicated by the resource space usage history.

18. The method of claim 11, wherein authenticating the first user identity occurs as a result of a radio-frequency identification reading of the first authentication input.

19. The method of claim 11, wherein authenticating the first user identity occurs as a result of a near field communication established between the first authentication input and a near field communication reader.

20. A computer readable medium including instructions stored therein which, when executed by a processor, cause the processor to perform operations comprising:
receive, from a first user, a request for authenticating a first user identity based on a first authentication input;
authenticate, based on access to a user database and the first authentication input, the first user identity;
access a first user account associated with the first user identity;
identify first scheduled event in which the first user account is designated as a potential attendee;
offer the first user, by reference to a resource management system, access to a first resource space for use during the first scheduled event, the first resource space including a first telecommunications device; and
automatically establish a connection between the first telecommunications device and a system hosting the first scheduled event.
